(19) United States
(12) Patent Application Publication
(10) Pub. No.: US 2013/0025535 A1
(43) Pub. Date: Jan. 31, 2013

(54) SLOT DIE FOR IMPROVING COATING UNIFORMITY

(71) Applicants: Dong Kwon Choi, Gyeonggi-do (KR); Jang Hwan Lee, Seoul (KR); Dong Hoon Kim, Seoul (KR)

(72) Inventors: Dong Kwon Choi, Gyeonggi-do (KR); Jang Hwan Lee, Seoul (KR); Dong Hoon Kim, Seoul (KR)

(73) Assignee: SUNG AN MACHINERY CO., LTD., Gyeonggi-do (KR)

(21) Appl. No.: 13/484,599

(22) Filed: May 31, 2012

(30) Foreign Application Priority Data
Jul. 27, 2011 (KR) 10-2011-0074390

(51) Int. Cl. B05C 5/02

(52) U.S. Cl. 118/302

(57) ABSTRACT

Provided is a slot die for improving coating uniformity including a main body, a cavity formed in the main body, an introduction part formed at an upper portion of the main body to supply a coating solution into the cavity, an injection unit configured to provide an external ejection path for the coating solution with respect to a portion of or the entire cavity, and a guide member arranged in the cavity to help diffusion of the coating solution to the injection unit.

Accordingly, the guide member arranged in the cavity can induce diffusion of the ejected coating solution so that the coating solution can be more uniformly applied.

### CROSS-REFERENCE TO RELATED APPLICATIONS

This application claims priority to and the benefit of Korean Patent Application No. 2011-0074390, filed Jul. 27, 2011, the contents of which are incorporated herein by reference in its entirety.

### BACKGROUND

1. Field of the Invention

The present invention relates to a slot die for improving coating uniformity, and more particularly, to a slot die capable of uniformly applying a coating solution by installing a guide member in a cavity of the slot die to help diffusion of the coating solution.

2. Discussion of Related Art

In the related art of a slot die for improving coating uniformity, a slot die including the following is disclosed: the slot die includes a slurry supply line connected to an external slurry supply source, a cavity connected to the slurry supply line, and a slot connected to the cavity via a gap to apply a slurry on a base material, and a flow path adjustment unit such as an auxiliary partition or an auxiliary block installed in the cavity to adjust a space shape of the cavity connected to the slurry supply line, thereby securing coating uniformity through exchange of the auxiliary block and adjustment of the auxiliary partition.

### SUMMARY OF THE INVENTION

While the related art provides a slot die in which a width of the cavity is adjusted according to a connection position of the supply line through the flow path adjustment unit such as the auxiliary block or the auxiliary partition to secure coating uniformity, the auxiliary block or the auxiliary partition must be separately manufactured to conform with a shape and size of the slot die or a shape and size of the cavity and the auxiliary block or the auxiliary partition must be assembled in the cavity, complicating manufacture and assembly thereof and increasing manufacturing cost of the slot die.

In order to solve the problem, the present invention is directed to a slot die for improving coating uniformity, including:
a main body;
a cavity formed in the main body;
an introduction part formed at an upper portion of the main body to supply a coating solution into the cavity;
an injection unit configured to provide an external ejection path for the coating solution with respect to a portion of or the entire cavity; and
a guide member arranged in the cavity to help diffusion of the coating solution to the injection unit.

Here, the guide member may be constituted by a plurality of ceramic balls distributed and remaining in the cavity.

### BRIEF DESCRIPTION OF THE DRAWINGS

The above and other objects, features and advantages of the present invention will become more apparent to a person with ordinary skill in the art to which the present invention pertains (hereinafter “skilled person”) by describing in detail example embodiments thereof with reference to the attached drawings, in which:

FIG. 1 is a perspective view of a slot die in accordance with an exemplary embodiment of the present invention;

FIG. 2 is an exploded perspective view of FIG. 1;

FIG. 3 is a cross-sectional view of FIG. 1;

FIG. 4 is a cross-sectional view taken along line A-A of FIG. 3;

FIG. 5 is a cross-sectional view taken along line B-B of FIG. 3;

FIG. 6 is an exploded perspective view of a slot die in accordance with another exemplary embodiment of the present invention; and

FIG. 7 is a front view of a first half and a shim plate of FIG. 6.

### DETAILED DESCRIPTION OF EXAMPLE EMBODIMENTS

Hereinafter, exemplary embodiments of the present invention will be described in detail with reference to the accompanying drawings.

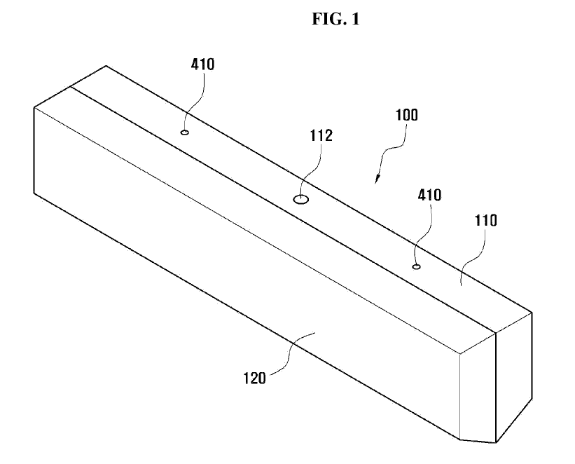

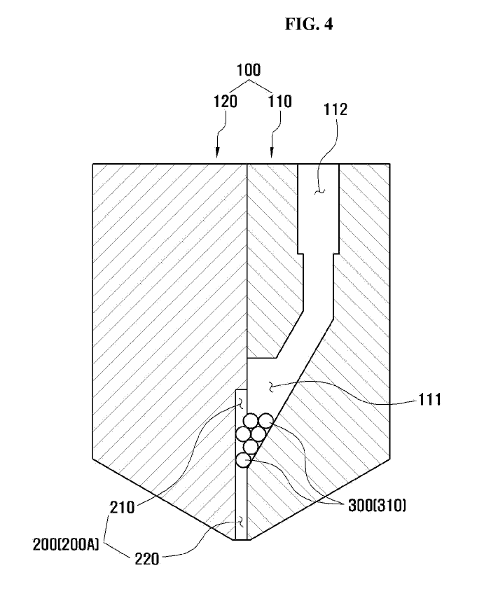

As shown in FIGS. 1 to 7, a slot die for improving coating uniformity (hereinafter referred to as a “slot die”) in accordance with the present invention generally includes a main body 100, an injection unit 200 and a guide member 300.

Hereinafter, reviewing each component, the main body 100, which forms an entire appearance of the slot die, includes a cavity 111 formed therein, and an introduction part 112 formed at an upper portion thereof to supply a coating solution into the cavity 111.

In addition, the main body 100 includes a first half 110 having the cavity 111 and the introduction part 112, and a second half 120 coupled to the first half 110 to cover the cavity 111. A coating solution supply apparatus (not shown) is connected to the introduction part 112 to supply the coating solution into the cavity 111.

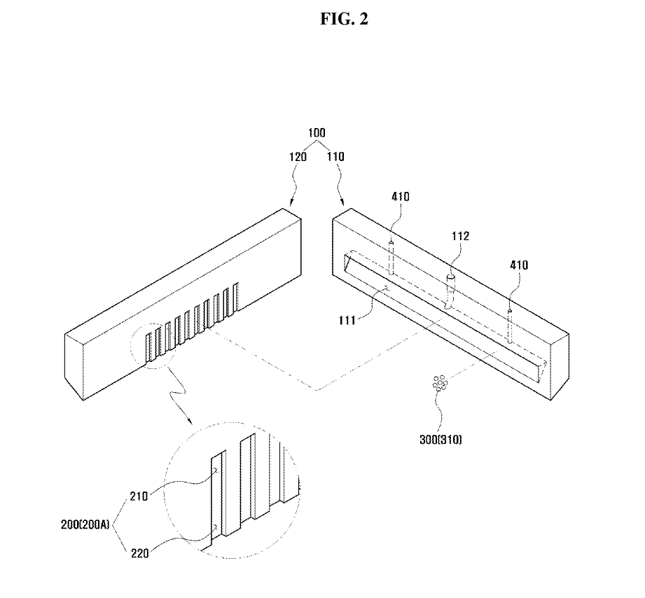

The injection unit 200 provides an external ejection path for the coating solution to a portion of or the entire cavity 111. As shown in FIGS. 2 to 5 and FIGS. 6 and 7, the injection unit 200 may be provided as first and second examples.

Referring to each example, as shown in FIGS. 2 to 5, an injection unit 200A according to the first example includes a plurality of inlet parts 210 arranged partially or entirely on the region of the second half 120 in a straight line at predetermined intervals to cover the cavity 111 of the first half 110, and a plurality of ejection parts 220 in communication with the inlet parts 210 and extending to a lower end of the second half 120.

Eventually, each of the inlet parts 210 and each of the ejection parts 220 in mutual communication with each other form a single groove to provide an ejection path such that the coating solution supplied into the cavity 111 can be ejected toward a lower side of the main body 100.

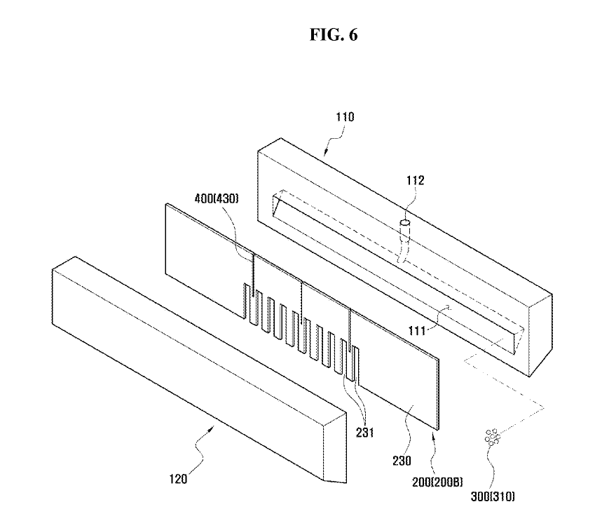

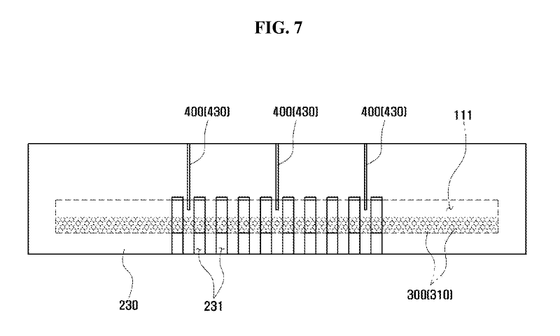

In addition, as shown in FIGS. 6 and 7, an injection unit 200B according to the second example includes a shim plate 230 interposed between the halves 110 and 120 of the main body 100 and having a plurality of bottom-open type slit ejection parts 231 arranged partially or entirely on the region of the first half 110 facing the cavity 111 in a straight line at predetermined intervals.

Here, the shim plate 230 has an area corresponding to an area of a surface between the facing halves 110 and 120 so that the shim plate 230 can be closely disposed between the halves 110 and 120 and thus preventing leakage of the coating solution through a section in which the slit ejection part 231 is not formed.

In addition, the slit ejection part 231 has an upper portion in communication with the cavity 111 and a lower opening to provide an ejection path such that the coating solution supplied into the cavity 111 can be ejected to a lower side of the main body 100.

Meanwhile, as shown in the FIGS. 6 and 7, in the injection unit 200A and 200B in the first and second examples, while the inlet part 210, the ejection part 220, and the slit ejection part 231 are arranged at a partial region of a center in a longitudinal direction of the cavity 111, they may be arranged throughout the entire region of the cavity 111 as required.

The guide member 300 is arranged in the cavity 111 to help diffusion of the coating solution to the injection unit 200.

The guide member 300 may be formed of a plurality of ceramic balls 310 distributed and remaining in the cavity 111 so that the coating solution can be easily diffused through gaps between the distributed ceramic balls 310 and the guide member 300 can be prevented from being corroded and eroded by the coating solution due to good corrosion-resistance.

Here, “remaining” means that a diameter of each of the ceramic balls 310 is larger than the ejection path of the injection unit 200, and thus, the ceramic balls 310 remain in the cavity 111, rather than being ejected with the coating solution ejected through the injection unit 200.

In addition, the ceramic balls 310 may have various diameters according to a size of the cavity 111, viscosity of the coating solution, an injection pressure, and so on, as long as the ceramic balls 310 are distributed and remain in the cavity 111.

Further, the guide member 300 is not limited to the ceramic balls 310 but may be variously changed and modified in shape and material as long as they are distributed and remain in the cavity 111 to help diffusion of the coating solution.

Eventually, the guide member 300 is formed of the plurality of the ceramic balls 310 distributed in the cavity 111. Here, gaps are generated between the ceramic balls 310 so that the coating solution can be diffused to flow therethrough and concentrated ejection of the coating solution through the ejection path near the introduction part 112 can be prevented, improving coating uniformity.

Meanwhile, the slot die in accordance with the present invention may further include an air pressure release unit 400 with respect to the cavity 111.

The air pressure release unit 400 functions to prevent a decrease in coating uniformity or generation of defects on a coating surface caused by imperfect discharge of air filled in the cavity 111 during a process of supplying the coating solution into the cavity 111 or inflow of the air generated by the coating solution supply apparatus into the cavity 111 and thus ejection of the air with the coating solution.

The air pressure release unit 400 may be implemented by providing an air discharge path such that the air in the cavity 111 can be discharged by a supply pressure of the coating solution. As shown in FIGS. 2, 3 and 5, and 6 and 7, the air discharge path may be constituted by a discharge port 410 formed at an upper portion of the first half 110 to communicate with the cavity 111 according to the example of the injection unit 200, or a top-open type discharge slit 430 formed at the shim plate 230 to communicate with the cavity 111.

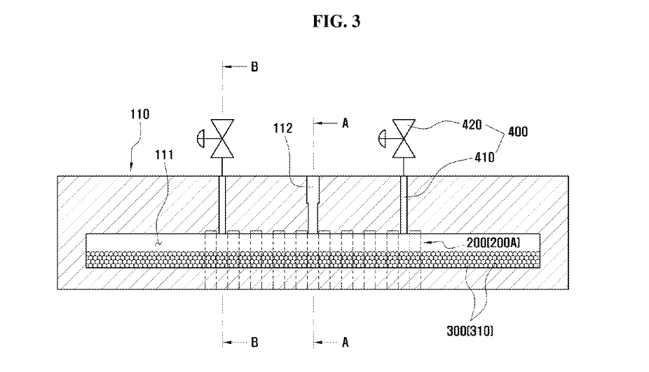

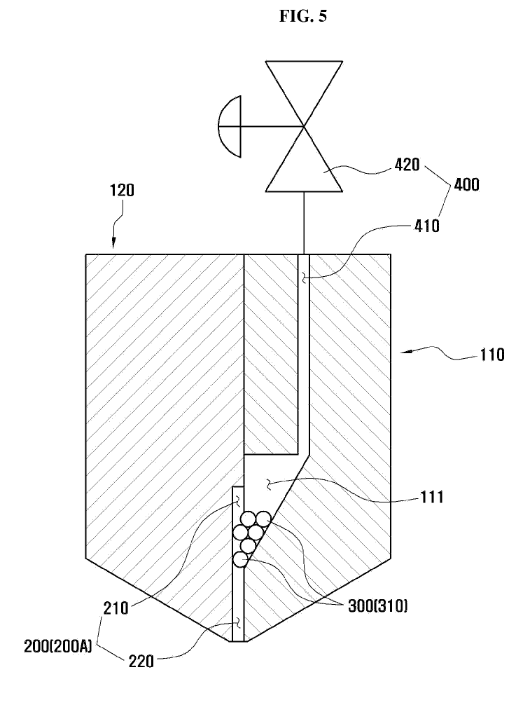

Here, as shown in FIGS. 3 and 5, when the air discharge path is constituted by the discharge port 410, an exhaust valve 420 may be further connected to the discharge port 410.

The exhaust valve 420 is configured to be opened upon air discharge and closed upon completion of discharge to prevent leakage of the coating solution. The exhaust valve 420 may be manually opened/closed by a user, or may be automatically opened/closed by a separate controller.

In addition, a separate pressure gauge may be connected to the exhaust valve 420 as required to use the gauge as an indicator for stably controlling a coating process.

Further, when the air discharge path is constituted by the discharge slit 430, the discharge slit 430 may be minutely formed such that the air can be discharged but the coating solution cannot be leaked. In order to prevent the leakage of the coating solution, a separate end cap (not shown) inserted into the discharge slit 430 may be provided, as required.

Finally, the air pressure release unit 400 can remove the air in the cavity 111 to smoothly eject the coating solution through the injection unit 200 according to a flow rate of the coating solution supplied into the cavity 111 by the coating solution supply apparatus without being subject to the influence of the ejected air, and thus, the coating surface formed by the slot die of the present invention can secure good reproducibility and thickness uniformity.

As can be seen from the foregoing, the slot die for improving coating uniformity can allow the guide member arranged in the cavity to induce diffusion of the ejected coating solution so that the coating solution can be more uniformly applied.

In addition, as the guide member is constituted by the plurality of ceramic balls, it can be easily manufactured and easily adapted to an already-made slot die.

While the invention has been shown and described with reference to “the slot die for improving coating uniformity” of certain example embodiments thereof having specific shapes and structures, it will be understood by an skilled person that various changes in form and details may be made therein without departing from the spirit and scope of the invention as defined by the appended claims.

What is claimed is:

1. A slot die for improving coating uniformity comprising:
a main body;
a cavity formed in the main body;
an introduction part formed at an upper portion of the main body to supply a coating solution into the cavity;
an injection unit configured to provide an external ejection path for the coating solution with respect to a portion of or the entire cavity; and
a guide member arranged in the cavity to help diffusion of the coating solution to the injection unit,
wherein the guide member is constituted by a plurality of ceramic balls distributed and remaining in the cavity.

2. The slot die for improving coating uniformity according to claim 1, wherein the main body comprises a first half having the cavity and the introduction part, and a second half coupled to the first half to cover the cavity.

3. The slot die for improving coating uniformity according to claim 2, wherein the injection unit comprises:
a plurality of inlet parts straightly arranged partially or entirely on the region of the second half to cover the cavity of the first half at predetermined intervals; and
a plurality of ejection parts in communication with the inlet parts, respectively, and extending to a lower end of the second half.

4. The slot die for improving coating uniformity according to claim 2, wherein the injection unit is constituted by a shim plate disposed between the halves of the main body and having a plurality of bottom-open type slit ejection parts straightly formed partially or entirely on the region of the first half facing the cavity at predetermined intervals.

5. The slot die for improving coating uniformity according to any one of claims 2 to 4, further comprising an air pressure release unit with respect to the cavity,
wherein the air pressure release unit comprises:
a discharge port formed at an upper portion of the first half to communicate with the cavity; and
an exhaust valve connected to the discharge port.

6. The slot die for improving coating uniformity according to claim 4, further comprising an air pressure release unit for the cavity,
wherein the air pressure release unit is constituted by a top-open type discharge slit formed at the shim plate to communicate with the cavity.
